(19) United States
(12) Patent Application Publication
(10) Pub. No.: US 2002/0138498 A1
(43) Pub. Date: Sep. 26, 2002

(54) System and method for preserving medical data

(75) Inventor: Katsuya Suzuki, Sagamihara-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 09/897,750

(22) Filed: Jun. 29, 2001

(30) Foreign Application Priority Data
Jun. 30, 2000 (JP) 2000-199742

(51) Int. Cl. G06F 7/00

(52) U.S. Cl. 707/104.1

(57) ABSTRACT

According to the present invention, medical image data such as image data produced by an endoscope system stored in a mass storage device that is installed in a medical institution are backed up in a backup server over the Internet. The backup server is managed by a service provider, according to a contract made by a service receiver with the service provider. Moreover, the service receiver makes a contract with the service provider by accessing a web server owned by the service provider at an endoscope server system or a personal computer connected to the Internet.

This application claims benefit of Japanese Application No. 2000-199742 filed in Japan on Jun. 30, 2000, the contents of which are incorporated by this reference.

### BACKGROUND OF THE INVENTION

1. Field of the Invention

The present invention relates to a medical data preservation system and medical data preservation method for transferring electronic medical data, which includes medical information, over a communication line.

2. Description of the Related Art

In recent years, a technology aiming at the field of medicine in which endoscope systems are utilized has been widely adopted in medical practice. The technology converts images produced by an endoscope system into digital image data of a predetermined form, which can undergo image processing, for the benefit of diagnosis and cure.

Incidentally, in recent years, a sophisticated information-oriented society has come along and fast broadband transmission has become realistic. Various kinds of digital data can be readily transferred over computer networks including the so-called Internet or intranets.

Under the circumstances, networking has progressed even in the field of medicine. For example, a local area network (LAN) is constructed on the premises of hospitals or any other medical institutions, and the LAN is connected to the Internet. Consequently, a user can transfer various kinds of data irrespective of whether he/she is in the medical institution. Medical information including medical image data produced by an endoscope system or the like is utilized in various forms over networks.

For example, according to an image data use form that is well-known, information including medical image data is stored (recorded) in a predetermined server, and dedicated software is used to retrieve or read the image data.

By the way, this kind of image data in general has a large amount. Despite the advancement of a data compression technology, the amount of data keeps on increasing these days. Therefore the amount of image information that can be stored on the premises of a medical institution has its limit. Moreover, generally speaking, there is a fear that stored data may be lost due to an unforeseen happening. In case of the unforeseen happening, a plurality of backup facilities must be installed in the institution. This invites an increase in costs. Besides, the data management cannot be said to be perfect.

On the other hand, the aforesaid image data use form for the construction of a system for storing (recording) and managing image information in a predetermined server over the Internet has such inconveniences as need dedicated software to present recorded images when downloaded. Consequently, image data can be utilized only in a complicated stereotyped manner.

### OBJECT AND SUMMARY OF THE INVENTION

Accordingly, an object of the present invention is to provide a medical data preservation system and a medical data preservation method for reliably and inexpensively producing and managing a backup copy of data over a communication line, in compliance with a user's need.

Briefly, according to the present invention, there is provided a medical data preservation system comprising a medical data receiving means, a medical data storage means, a storage condition designating means, and a control means. The medical data receiving means receives electronic medical data including medical information over a communication line. The medical data received by the medical data receiving means is stored in the medical data storage means. A condition for storage in the medical data storage means is designated at the storage condition designating means. The control means controls the data-stored state of the medical data storage means according to the condition for storage designated at the storage condition designating means.

These objects and advantages of the present invention will become further apparent from the following detailed explanations.

### BRIEF DESCRIPTION OF THE DRAWINGS

FIG. 1 is an explanatory diagram showing the configuration of a medical data preservation system in accordance with a first embodiment of the present invention;

FIG. 2 is a flowchart describing a terms-of-contract setting routine implemented in the medical data preservation system in accordance with the first embodiment;

FIG. 3 is a flowchart describing a service use period setting routine implemented in the medical data preservation system in accordance with the first embodiment;

FIG. 4 is a flowchart describing an accounting routine implemented in the medical data preservation system in accordance with the first embodiment;

FIG. 5 is a flowchart describing an image data storing routine implemented in the medical data preservation system in accordance with the first embodiment;

FIG. 6 is a flowchart describing a backup job routine implemented in the medical data preservation system in accordance with the first embodiment;

FIG. 7 is a conceptual diagram showing an entire storage area in a backup server accommodated by a medical data preservation system in accordance with a second embodiment of the present invention;

FIG. 8 is an explanatory diagram showing an example of a presentation tool employed in the medical data preservation system in accordance with the second embodiment;

FIG. 9 is an explanatory diagram showing a use form for a medical data preservation system in accordance with a third embodiment of the present invention;

FIG. 10 is an explanatory diagram showing a use form for a medical data preservation system in accordance with a fourth embodiment of the present invention;

FIG. 11 is an explanatory diagram showing a use form for a medical data preservation system in accordance with a fifth embodiment of the present invention; and

FIG. 12 is an explanatory diagram showing a use form for a medical data preservation system in accordance with a sixth embodiment of the present invention.

### DESCRIPTION OF THE PREFERRED EMBODIMENTS

Referring to the drawings, embodiments of the present invention will be described below.

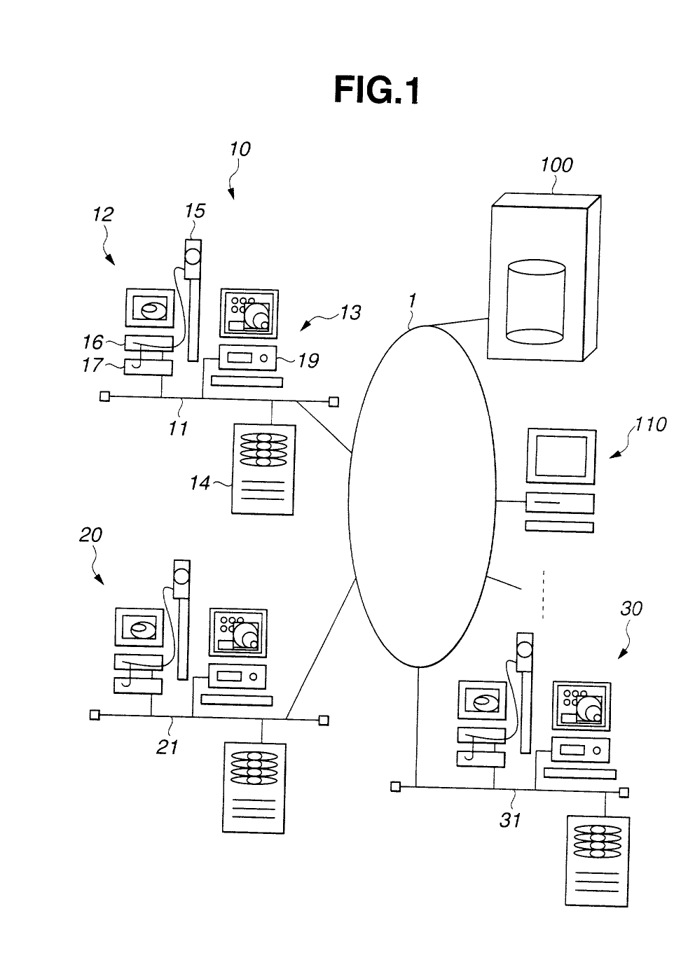

FIG. 1 is an explanatory diagram showing the configuration of a medical data preservation system in accordance with a first embodiment of the present invention.

As illustrated, the medical data preservation system in accordance with the present embodiment is characterized in that electronic medical data including medical image data, management information, and other medical information is transferred between medical institutions 10, 20, 30, etc. and a backup server 100 over the so-called Internet 1. Herein, the Internet 1 is an aggregate structure of networks that are interconnected and that adopt a common protocol and a common addressing method. A service provider manages the backup server 100.

Each medical institution that is accommodated by the medical data preservation system in accordance with the present embodiment shall have, for example, components described below.

Taking for instance a medical institution 10 shown in FIG. 1, an intra-institution network 11 is constructed in the institution. The intra-institution network 11 is a local area network (LAN) established in the institution 10. According to the present embodiment, the intra-institution network shall be a so-called intranet that requires the same environment as the Internet does. The intra-institution network 11 is connected to the Internet 1. Terminals connected to the intra-institution network 11 can transfer information or share the same information by following the same procedure irrespective of whether the terminals are placed on the premises of the institution.

Moreover, the terminals constituting the intra-institution network 11 supposedly include an endoscope system 12, an endoscope server system 13, and a mass storage device 14.

The endoscope system 12 consists mainly of a known endoscope 15, a video center 16 having a CCU incorporated therein, a light source apparatus 17, and a monitor 18. Medical images of a subject picked up by the endoscope 15 are displayed on the monitor 18 under the control of the video center 16. The displayed medical images are utilized for a predetermined medical deed. The endoscope system 12 shall have known abilities, and the description of the endoscope system is omitted.

According to the present embodiment, the endoscope server system 13 is realized with a personal computer and connected to the intra-institution network 11. Specifically, the endoscope server system 13 is connected to the endoscope system 12 over the intra-institution network 11, and connected to the backup server 100 over the Internet 1 to which the intra-institution network 11 is connected.

The first capability of the endoscope server system 13 is to read image data concerning subject images, which is produced by the endoscope system 12, to file the image data, and to store the image data together with predetermined management information in a storage device 19 (for example, a hard disk drive) accommodated by the system. Moreover, the image data that has been filed and stored in the storage device 19 can be observed using the monitor. Incidentally, this capability is supposedly realized with a known software system, and the description of the facility is omitted.

The second capability of the endoscope server system 13 is to play the role of a terminal for reading image data backed up in the backup server 100. The second capability will be detailed later.

Furthermore, the third capability of the endoscope server system 13 is to play the role of a terminal at which a user trying to receive a backup service accesses a web server 110 owned by a service provider over the Internet 1, and designates a contract and the predetermined terms of the contract. That is to say, the endoscope server system 13 plays the role of a means for use in designating a condition for storage of information in the backup server 100.

The mass storage device 14 is a device (for example, a magnetic disk drive) in which a large amount of data placed on the intra-institution network 11 can be stored. In addition to the aforesaid image data, various kinds of information acquired at the medical institution 10 can be stored in the mass storage device 14. According to the present embodiment, the mass storage device 14 plays the role of a storage device in which image data and management information stored in the storage device 19, which has a relatively small storage capacity and is included in the endoscope server system 13, are stored over the intra-institution network 11 periodically or at any time. Needless to say, the information stored in the mass storage device 14 can be read at various terminals interconnected over the intra-institution network 11 with parameters set for reading the information.

In addition to the endoscope system 12, endoscope server system 13, and mass storage device 14, various terminals that are interconnected over an ordinary intranet can be interconnected over the intra-institution network 11. However, the terminals have no direct relation to the present invention, and the description of the terminals is therefore omitted.

As shown in FIG. 1, a plurality of endoscope systems and a plurality of endoscope server systems can be installed in the medical institution 10 instead of limiting the number of each system to one. In this case, storing common image data or the like in the mass storage device 14 enables a plurality of endoscope server systems 13 to have image data produced by any endoscope system 12. The description of this mechanism of sharing the same image data among a plurality of systems is omitted because the mechanism is based on a technique adopted for an existing network system.

The medical data preservation system in accordance with the present embodiment enables medical institutions 20 and 30, in which the similar intra-institution networks 21 and 31 are constructed, in addition to the medical institution 10, to connect to the backup server 100 over the Internet 1.

A service provider who provides a data backup service for users of the medical data preservation system in accordance with the present embodiment manages the backup server 100. The backup server 100 stores a backup copy of data concerning various kinds of medical information, which are acquired at the medical institutions 10, 20, and 30, over the Internet 1 according to the terms of a contract made with each user. Moreover, the backup server 100 manages the data.

In other words, the backup server 100 plays the roles of a medical data receiving means that receives electronic medical data including medical information over the Internet 1, and a medical data storage means in which the received data is stored, and a control means that controls a data-stored state according to the condition for storage set by the endoscope server system 13.

Moreover, the web server 110 installed at the service provider is connected to the Internet 1. A user of the data backup service, that is, a person concerned in each medical institution uses a terminal such as the endoscope server system 13 to access the web server 110 over the Internet 1. The user then designates any of various types of contracts for provision of the service provider and works out the terms of a contract. Needless to say, access to the web server 110 can be made not only at the endoscope server system 13 but also at any terminal that is a personal computer connected to the Internet 1.

Next, a use form of the medical data preservation system will be described by taking examples.

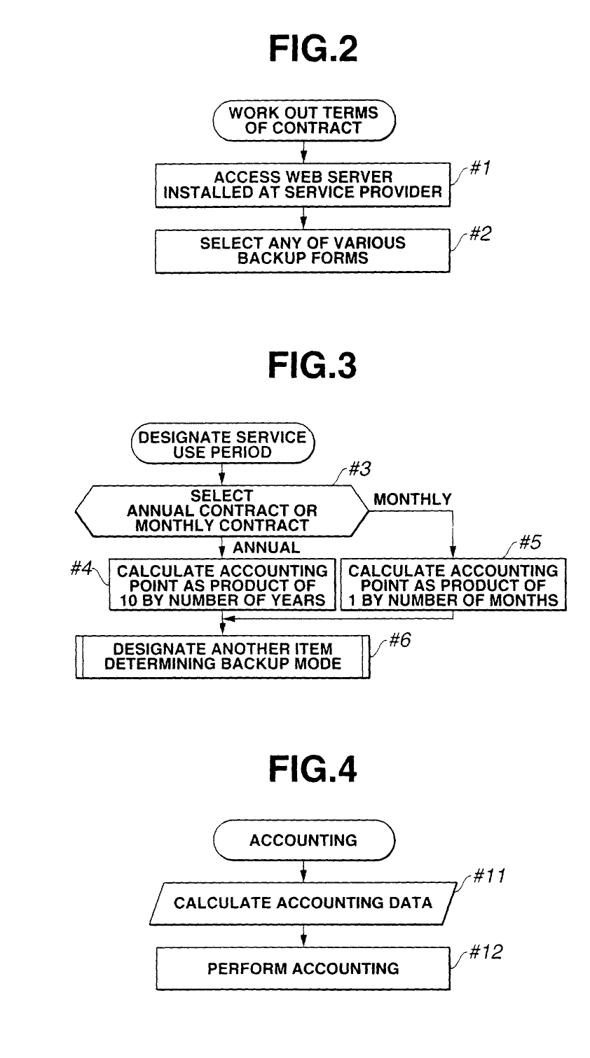

(1) Working out the terms of a contract (see FIG. 2 and FIG. 3)

A potential user accesses the web server 110 at a terminal (a terminal device in which a typical browser runs, for example, a personal computer) connected to the Internet 1, such as, the endoscope server system 13 (#1). The potential user having accessed the web server 110 selects any of various backup modes offered by a service provider, and makes a contract with the service provider (#2). The contract is made using any of various methods that utilize networks (the Internet), wherein the methods includes existing methods and methods to be devised in the future. The details of the methods have no direct relation to the present invention, and the description of the methods is therefore omitted.

According to the present embodiment, the terms of a contract a service provider and a service receiver work out, that is, the contents of a backup mode are as follows:

selection of a service use period

selection of backup timing

selection of a kind of a backup data

For the item of a service use period, the medical data preservation system of the present embodiment allows a user to designate the preservation period of a backup copy of medical information stored in the mass storage device 14 installed in the medical institution 10 either on an annual contract or on a monthly contract. According to the present embodiment, as described in FIG. 3, either the annual contract or monthly contract is selected in order to designate the service use period (#3). For the annual contract, an accounting point is calculated as a product of 10 by the number of years (#4). For the monthly contract, the accounting point is calculated as a product of 1 by the number of months (#5). After the accounting point is calculated, another term determining a backup mode is designated (#6).

Table 1 lists examples of accounting points.

TABLE 1

| Annual | Accounting | Number of | | |
|---|---|---|---|---|
| contract | point | years | Backup rate | Charge |
| One year: | 10 | 1 | 1000 | ¥10,000 |
| annually | | | | |
| Monthly | Accounting | Number of | | |
| contract | point | months | Backup rate | Charge |
| One month: | 01 | 12 | 1000 | ¥12,000 |
| updated | | | | |
| monthly | | | | |

Annual contract: backup is continued for one year. The contract is terminated after the elapse of one year.
Monthly contract: backup is continued for one month. The contract is terminated after the elapse of one month. When a monthly contract is updated monthly, the accounting point goes up to 12 and the charge becomes the same as the charge for the annual contract. An amount of data is fixed (has limits).

For the item of backup timing, the timing of backing up in the backup server 100 medical information stored in the mass storage device 14 is designated by selecting any of the followings:

periodically (for example, at a certain time during night)

every time the endoscope system 12 is used for examination

concurrently with storage of data in the mass storage device 14

For the item of a kind of a backup data, the medical data preservation system of the present embodiment allows a user to designate whether a backup data for each patient is preserved or not.

(2) Accounting (see FIG. 4)

Based on the terms of a contract, that is, a backup mode worked out through discussion between a service provider and a service receiver, the service provider who manages the backup server 100 calculates accounting data (#11). Based on the calculated data, accounting is performed on the user (#12). Although various methods are conceivable for the accounting, for the present embodiment, an existing method is adopted, and the description of the method is omitted.

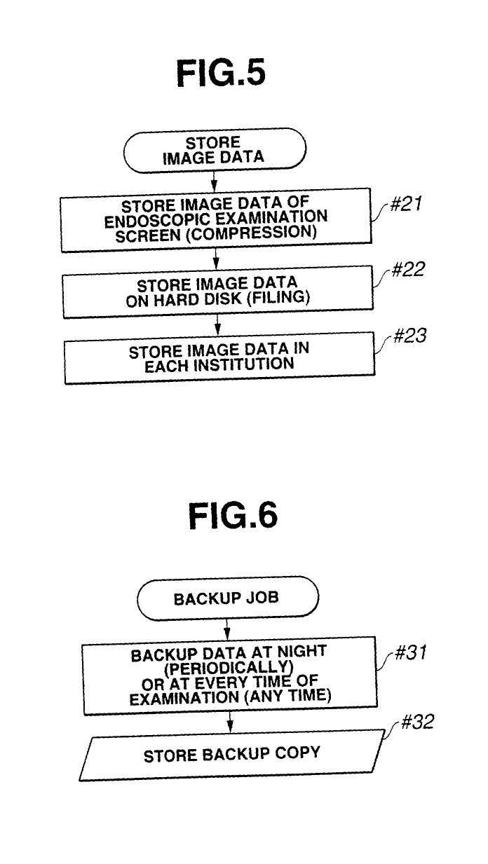

(3) Storing image data in the medical institution 10 (see FIG. 5)

A subject image produced by the endoscope system 12 is converted into predetermined digital image data that can undergo image processing, for example, data conformable to the JPEG (#21) by means of a personal computer which is not shown and which is connected to the video center 16. The image data produced by the personal computer can be fed into the endoscope server system 13 over the intra-institution network 11. The endoscope server system 13 files the image data, and stores the resultant data together with predetermined management information in the storage device 19 (#22).

Image data stored in the endoscope server system 13 may be stored in the mass storage device 14 (#23). It is designated whether data is stored in the mass storage device 14 periodically (for example, at a certain time during night) or every time the endoscope system 12 is used to perform examination.

(4) Backup job (see FIG. 6)

Based on the terms of a contract (backup mode), the backup server 100 receives predetermined medical image data and management information from the mass storage device 14 over the Internet 1, and stores (records) the data and information (#31). Thereafter, the backup copy is preserved and managed based on the terms of the contract (#32).

As mentioned above, the medical data preservation system of the present embodiment automatically and inexpensively preserves a backup copy of medical data, which is acquired at a medical institution, in compliance with a user's need (or a need of a person concerned in a medical institution) over such communication line established outside the medical institution as the Internet. Consequently, a large amount of valuable data such as medical data can be surely kept.

Incidentally, according to the present embodiment, the Internet is supposedly adopted as a communication line over which an intra-institution network (LAN) constructed in a medical institution and a backup server are connected. But the communication line is not limited to the Internet but includes a leased line or the like.

According to the present embodiment, data to be stored in a backup server is supposedly medical data (including medical image data) transferred over an intra-institution network constructed in a medical institution. The data to be stored is not limited to the medical data. The idea of the present invention can be adapted to a system for preserving a backup copy of any of various kinds of data that is produced in an ordinary social institution.

Moreover, according to the present embodiment, accounting is performed to charge for a backup service. Alternatively, the idea of the present invention can be adapted to any preservation system or method for providing a backup service without charge.

Next, a medical data preservation system in accordance with a second embodiment of the present invention will be described below.

The medical data preservation system in accordance with the second embodiment of the present invention has the same structure as the first embodiment shown in FIG. 1. According to the first embodiment, the backup server 100 aims at backing up medical information that is acquired at the medical institution 10, and its maintenance and management. In contrast, the medical data preservation system in accordance with the second embodiment provides services other than maintenance and management of a backup copy. Specifically, any storage area in the backup server 100 is rented to a user.

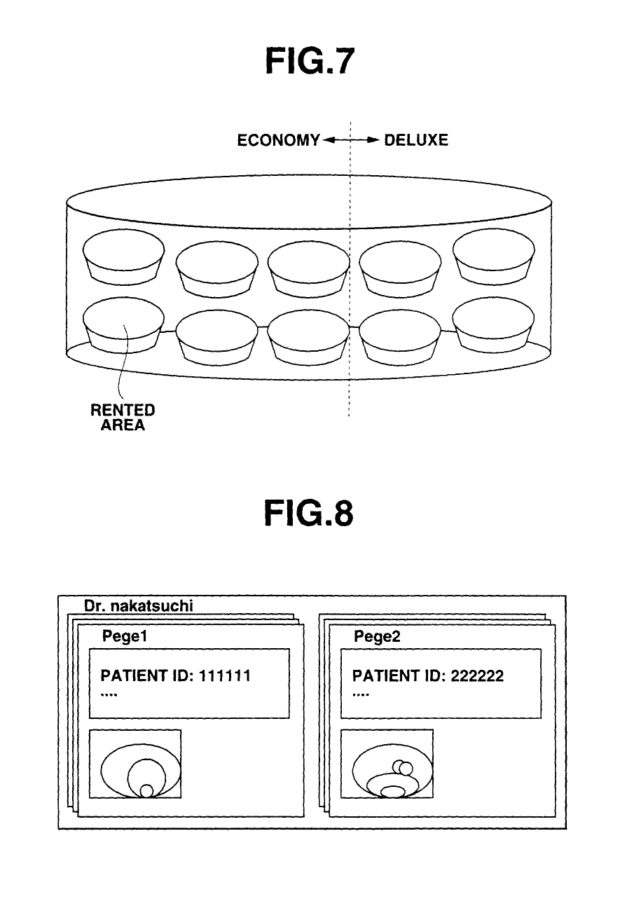

FIG. 7 is a conceptual diagram showing the entire storage area in the backup server 100 accommodated by the medical data preservation system in accordance with the second embodiment.

As illustrated, any storage area in the backup server 100 is regarded as a rented area and rented or released to a user according to a predetermined contract. As a result, the user regards the rented area as a data preservation server on the Internet 1 and uses it as a data preservation place.

Moreover, a classification of services can be designated on a rented area. For example, as illustrated, either an economy class available at a low price or a deluxe class that is a user-oriented service may be provided for a user to meet his/her needs more closely. In this case, the economy class only offers use of a predetermined storage area allocated by the server as a data preservation area. The deluxe class may add such service as periodical storage of a backup copy on a recording medium such as a CD-ROM as well as data preservation.

Moreover, instead of merely renting a server area, a presentation tool or any other software may be provided. Specifically, as shown in FIG. 8, it may provide as a basic set, a presentation tool that can manage clinical records of 100 cases, for example. The presentation tool presents orderly-arranged images as if to present an electronic album. A storage area for data of a unit of 50 cases may be provided as an additional area.

Moreover, if the presentation tool is also made usable at terminal equipment installed in institutions (for example, medical institutions 10, 20, etc. shown in FIG. 1), data can be shared among the institutions and it becomes more convenient.

Next, another examples of the aforesaid use for of a medical data preservation system will be described below.

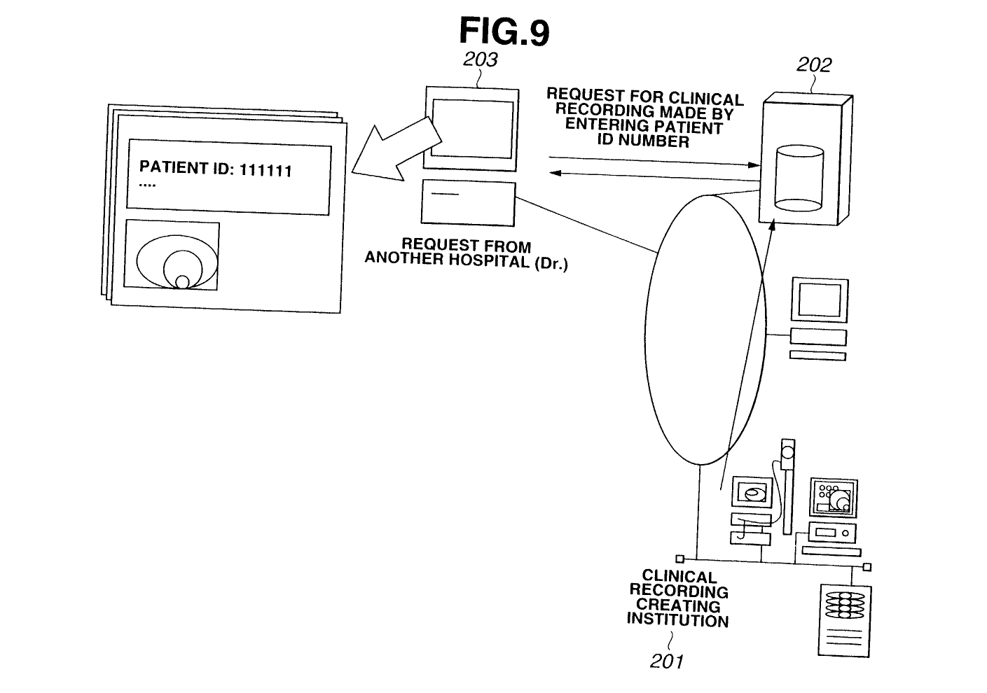

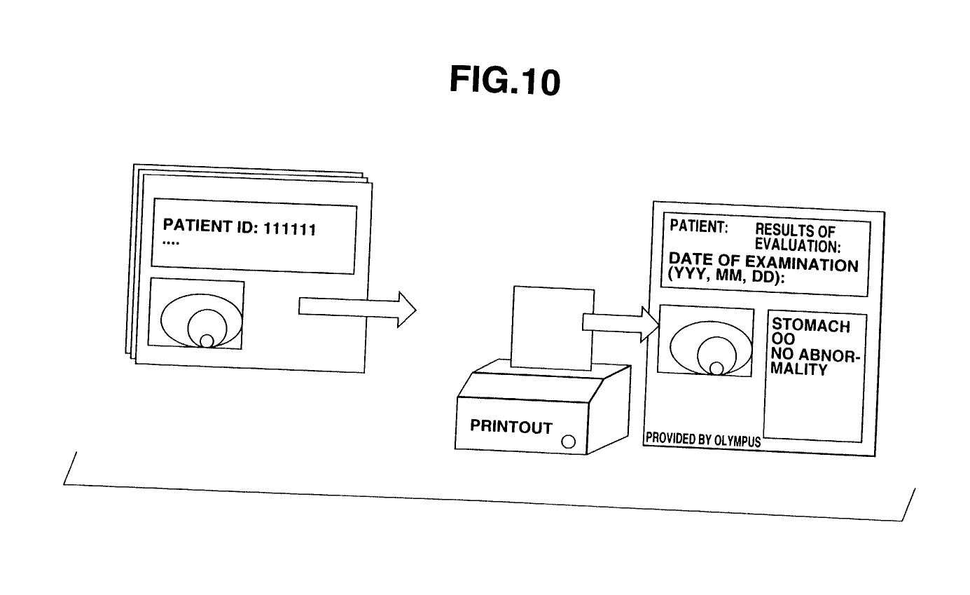

FIG. 9 and FIG. 10 are explanatory diagrams showing use forms of medical data preservation systems in accordance with third and fourth embodiments of the present invention.

As shown in FIG. 9, medical image information shall be treated in the form of a clinical recording at a predetermined medical institution 201. The medical data preservation system stores a backup copy of medical information data, for example, patient data in the form of a clinical recording in a backup server 202. At this time, if an identification (hereinafter ID) number is assigned to each patient, the clinical recording of the patient can be retrieved from the backup server 202 by entering the patient ID number even at another medical institution 203, that is, another hospital.

Moreover, a new service described below may be provided by treating medical image information in the form of a clinical recording. Specifically, a manager of a backup server converts the form of a clinical recording into a form understandable by any patient, and stores the resultant data in the server. As mentioned above, a system by which a patient can acquire his/her own clinical recording from the backup server by entering his/her patient ID number is assumed. According to the system even a patient who is not an expert in medicine can acquire his/her own clinical recording understandable by himself/herself and it becomes more convenient.

From a patient's point of view, the above system appears as if a manager (manufacturer) of a backup server issued a patient-specific clinical recording. As shown in FIG. 10, the name of a manufacturer acting as a provider may be appeared on a patient-specific clinical recording, resulting in working as an effective advertisement of the system and manufacturer.

The patient-specific clinical recording may be printed out to be sent to a patient by mail, or data of a clinical recording may be transferred to terminal equipment owned by the patient.

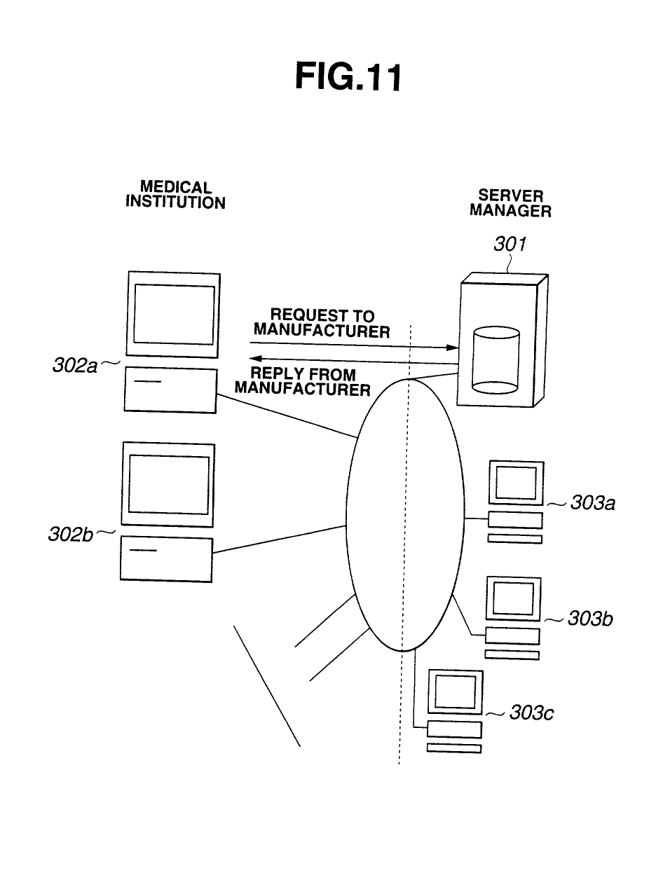

A system shown in FIG. 11 is conceivable as another use form of the medical data preservation system in accordance with the present embodiment.

FIG. 11 is an explanatory diagram showing a use form of a medical data preservation system in accordance with a fifth embodiment of the present invention.

The system releases storage areas in a backup server 301 owned by a server manager, and provides the storage areas for a plurality of medical institutions 302a, 302b, etc. How to use a storage area is up to each medical institution. A person concerned in each medical institution is given the authority to make a request to the server manager. On the other hand, an access authority permitting access to a storage area is exclusively given to the server manager, and the server manager retrieves or analyzes data.

In this system, when a person concerned in a medical institution makes a predetermined request, the server manager periodically receives the request as request data, and distributes the request data to any of departments 303a, 303b, and 303c depending on its request. The department having received the distributed data checks the contents of the request, and returns a reply to the backup server. The person concerned in the medical institution picks up information addressed to himself/herself from the server. In another case, the reply may be directly distributed to a terminal owned by the person concerned in the medical institution.

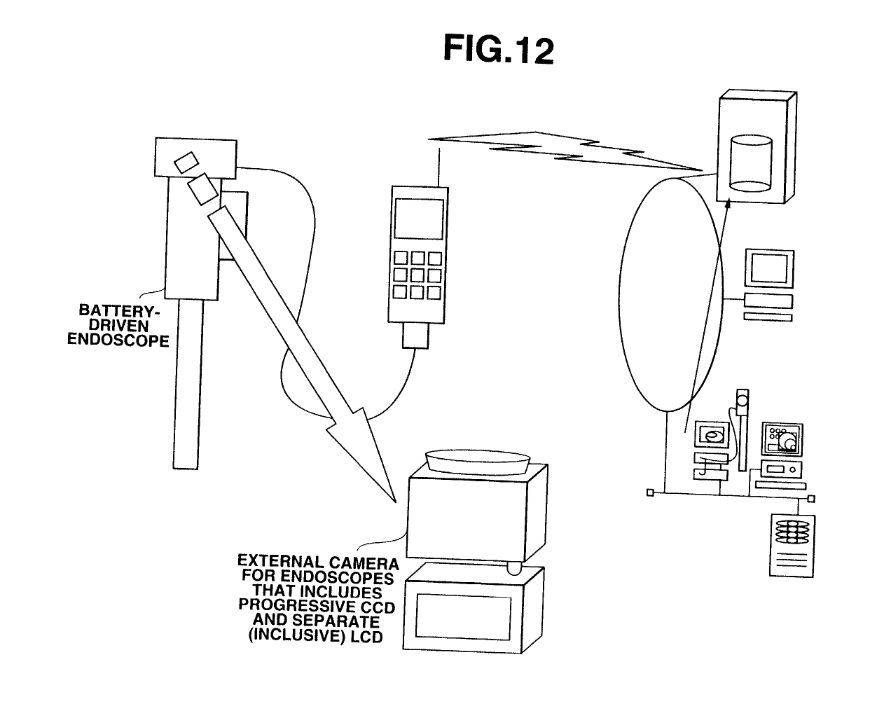

Furthermore, a system shown in FIG. 12 is conceivable as another use form of a medical data preservation system in accordance with the aforesaid embodiment. FIG. 12 is an explanatory diagram showing the use form of a medical data preservation system in accordance with a sixth embodiment of the present invention.

As an example of a service provided by a backup server, a service for keeping images of a predetermined kind may be provided by the backup server acting as a temporary management server.

Specifically, portable terminal equipment for transmitting data such as a portable telephone or a PHS and a battery-driven endoscope system are used in combination in order to transmit endoscopic images to the backup server by radio transmission. The backup server temporarily buffers the endoscopic images. A user retrieves a required image from the backup server later and obtains only a required image at any time.

As described so far, according to the present embodiment, a backup copy of medical data acquired at a medical institution can be stored automatically and inexpensively in compliance with a user's need (or a need of a person concerned in the medical institution) over a communication line established outside the medical institution, for example, the Internet. Consequently, a large amount of valuable data, including medical data, can be surely preserved.

In this invention, it is apparent that a wide range of different embodiments can be formed based on the invention without a departure from the spirit and scope of the invention. This invention is not restricted to any specific embodiment but limited to the appended claims.

What is claimed is:

1. A medical data preservation system comprising:
a medical data receiving means for receiving electronic medical data including medical information over a communication line;
a medical data storage means in which the medical data received by said medical data receiving means is stored;
a storage condition designating means for use in designating a condition for storage in said medical data storage means; and
a control means for controlling the data-stored state of said medical data storage means according to the condition for storage designated at said storage condition designating means.

2. A medical data preservation method comprising:
a medical data receiving step of receiving electronic medical data including medical information over a communication line;
a medical data storing step of storing the medical data received at said medical data receiving step in a medical data storage means;
a storage condition designating step of designating a condition for storage in said medical data storage means; and
a control step of controlling the data-stored state of said medical data storage means according to the condition for storage designated at said storage condition designating step.

3. A medical data preservation method for controlling backup of medical image data using a programmed computer, comprising the steps of:
selecting a backup mode in which medical image data is backed up;
backing up medical image data in a selected backup mode;
performing accounting according to the selected backup mode.

4. A medical data preservation system comprising:
an image backup device for preserving a backup copy of medical image data over a network over which information can be transferred; and
a control means for controlling the image backup device according to a backup mode.

5. A medical data preservation system according to claim 4, wherein the backup mode is determined through discussion between a service provider and a service receiver.

6. A medical data preservation system according to claim 5, wherein said control means controls a plurality of objects of backup, controls the objects of backup according to a determined backup mode, and performs accounting on each object of backup.

7. A medical data preservation system according to claim 4, wherein said control means controls said image backup device according to a backup mode, and performs accounting according to the backup mode.

8. A medical data preservation system according to claim 7, wherein said backup mode is determined through discussion between a service provider and a service receiver.

9. A medical data preservation system according to claim 8, wherein said control means can control a plurality of objects of backup, controls the objects of backup a ccording to a determined backup mode, and performs accounting on each object of backup.

10. A medical data preservation method comprising:
a method of backing up medical image data, which is stored in a storage device, in an image backup device over a network; and
a method of selecting a backup mode from among a plurality of backup modes, and designating the selected backup mode as the backing up method.

11. A medical data preservation method according to claim 10, wherein the medical image data is stored in said storage device, and backed up in said image backup device.

12. A medical data preservation method according to claim 10, wherein all of medical image data stored in said storage device is backed up at a time in an image backup device at any set time.

13. A medical data preservation method according to claim 10, wherein all of medical image data stored in said storage device and acquired at each medical institution is backed up at a time in an image backup device.

14. A medical data preservation method according to claim 10, wherein all of medical image data stored in said storage device is backed up for each patient at a time in an image backup device.

15. A medical data preservation method according to claim 10, wherein all of medical image data stored in said storage device is backed up for each examination at a time in an image backup device.

16. A medical data preservation method according to claim 10, wherein the backup mode is selected and designated based on a backup period and/or an amount of data to be backed up.

17. A medical data preservation method comprising:
a method of backing up medical image data, stored in a storage device in an image backup device over a network;
a method of selecting a backup mode from among a plurality of backup modes and designating the selected backup mode as the backing up method; and
a method of performing accounting so as to calculate a charge for backup according to the selected backup mode.

18. A medical data preservation method according to claim 17, wherein the charge for backup calculated as a product of an accounting point, depending on a backup mode, a period during which backup is continued, and a backup rate.
